(19) United States
(12) Patent Application Publication
(10) Pub. No.: US 2004/0131536 A1
(43) Pub. Date: Jul. 8, 2004

(54) Purification of sulfuryl fluoride

(75) Inventors: Heinz-Joachim Belt, Burgwedel (DE); Thomas Schwarze, Ahlten (DE); Matthias Rieland, Hannover (DE); Eckhard Hausmann, Hannover (DE)

Correspondence Address: CROWELL & MORING LLP, INTELLECTUAL PROPERTY GROUP, P.O. BOX 14300, WASHINGTON, DC, 20044-4300, US

(73) Assignee: Solvay Fluor und Derivate GmbH, Hannover (DE)

(21) Appl. No.: 10/657,710

(22) Filed: Sep. 9, 2003

Related U.S. Application Data
(63) Continuation of application No. PCT/EP02/02134, filed on Feb. 28, 2002.

(30) Foreign Application Priority Data
Mar. 9, 2001 (DE) 101 11 302.1

(51) Int. Cl. C01B 17/45

(52) U.S. Cl. 423/512.1

(57) ABSTRACT

A method of effectively purifying sulfuryl fluoride, which is useful as an insulating gas in electrical devices or as a pesticide and which frequently is contaminated with sulfur dioxide, hydrogen fluoride and/or hydrogen chloride. In the method, contaminated sulfuryl fluoride is contacted with or conducted over an alkali fluoride, e.g. potassium fluoride. The purification can be carried out during sulfuryl fluoride production, during storage of sulfuryl fluoride and/or before or during use of the sulfuryl fluoride, for example, as a pesticide.

### CROSS REFERENCE TO RELATED APPLICATIONS

This application is a continuation of international patent application no. PCT/EP02/02134, filed Feb. 28, 2002, designating the United States of America, and published in German as WO 02/072472, the entire disclosure of which is incorporated herein by reference. Priority is claimed based on Federal Republic of Germany patent application no. DE 101 11 302.1, filed Mar. 9, 2001.

### BACKGROUND OF THE INVENTION

The present invention relates to a method for producing purified sulfuryl fluoride.

Sulfuryl fluoride has dielectric properties and has been used as an insulating gas for electrical devices, e.g., for transformers, cables or switches. See Griffiths, U.S. Pat. No. 3,674,696.

Sulfuryl fluoride can also be used as a pesticide. As a result of the production process, the crude sulfuryl fluoride product may still contain hydrogen fluoride, hydrogen chloride and/or sulfur dioxide and possibly also organic impurities, such as dichloroethane. It is possible to purify sulfuryl fluoride by water scrubbing. This humidifies the gas, however, and hydrolysis may occur with hydrogen fluoride formation.

### SUMMARY OF THE INVENTION

The object of the present invention is to provide an improved method with which sulfuryl fluoride can be effectively purified.

Another object is to provide a sulfuryl fluoride purification method which avoids introducing moisture into the purified sulfuryl fluoride.

A further object of the invention is to provide a sulfuryl fluoride purification method which does not promote hydrolysis of the sulfuryl fluoride.

It is also an object of the invention to provide a sorbent kit with which sulfuryl fluoride can be purified.

In a first aspect, the objects are achieved in accordance with the present invention by providing a method for purifying contaminated sulfuryl fluoride containing at least one contaminant selected from the group consisting of hydrogen fluoride, hydrogen chloride, sulfur dioxide and organic impurities, said method comprising contacting the contaminated sulfuryl fluoride with an alkali metal fluoride and recovering a purified sulfuryl fluoride.

In another aspect, the objects are achieved by providing a sorbent kit comprising separate portions of an alkali metal fluoride and at least one adsorbent selected from the group consisting of activated carbon, silica gel and zeolites.

The method according to the invention for producing purified sulfuryl fluoride from contaminated sulfuryl fluoride, containing hydrogen fluoride, hydrogen chloride and/or sulfur dioxide as well as possibly organic impurities, provides that the contaminated sulfuryl fluoride is contacted with an alkali metal fluoride. A preferred alkali metal fluoride is potassium fluoride, which exists in a solid phase.

The crude product to be purified is preferably contacted with the alkali fluoride at a temperature ranging from −20° C. to 150° C., preferably 0° C. to 30° C.

The contaminated sulfuryl fluoride can be purified by bringing it into contact with an alkali metal fluoride immediately after its production. It may also be purified immediately prior to use or even during use. For example, sulfuryl fluoride prior to being used as an insulating gas or a pesticide can be passed over an alkali metal fluoride to remove impurities.

As an alternative or in addition thereto, when sulfuryl fluoride is being used as an insulating gas or a fumigant, a portion of the gas or fumigation atmosphere may be recirculated and in the process contacted with an alkali metal fluoride.

It is also possible to store the sulfuryl fluoride over an alkali metal fluoride. The method can of course also be used repeatedly, e.g., directly after production and directly prior to use or during use.

The alkali metal fluoride may also be used in combination with other adsorbents. It may be used, for example, together with activated carbon or with drying agents.

The contaminant-laden alkali metal fluoride can be regenerated, e.g., thermally.

The advantage of the method is that the purified sulfuryl fluoride is not laden with water. Water is undesirable because it causes slow hydrolysis of the sulfuryl fluoride. When sulfuryl fluoride is used as a pesticide, increased air moisture is undesirable, because the hydrolysis product, hydrogen fluoride, attacks, for example, objects or even the walls of the rooms themselves (especially in lime stone buildings). Of course, this also applies to electrical devices.

The sulfuryl fluoride purified according to the invention has a low moisture content. A further advantage is that the alkali metal fluoride can be regenerated. Activated carbon or other sorbents such as silica gel beads used together with the alkali metal fluoride (e.g., for separating water) may also be thermally regenerated.

The invention also relates to a sorbent kit, which contains, or consists of, an alkali metal fluoride, preferably potassium fluoride, and at least one other solid sorbent. Possible sorbents are those capable of adsorbing water, halogens or organic compounds. Preferably, the sorbent kit contains activated carbon, silica gel and/or zeolite in addition to an alkali metal fluoride.

Such a sorbent kit enables the separation not only of hydrogen fluoride, hydrogen chloride and sulfur dioxide, but also of water or organic components, e.g., dichloroethane, that may be contained in the sulfuryl fluoride. This is advantageous not only when purifying the crude product directly after production but also, and in particular, during use. When used as an insulating gas or a pesticide, for example, hydrolysis products of the sulfuryl fluoride and even water can be removed in this manner.

The alkali metal fluoride and the additional solid sorbent present in the sorbent kit may be mixed or separate, in the form of a powder, a granulate, pellets, an extrudate or in some other form.

The following example is intended to illustrate the invention in greater detail without, however, limiting its scope.

### EXAMPLE 1

### Purification of Sulfuryl Fluoride with Potassium Fluoride and Activated Carbon

A 2-liter adsorbent vessel was used. This vessel was filled with a bottom layer of activated carbon, followed by a potassium fluoride layer and a final activated carbon layer. The test gas used was 3 kg of sulfuryl fluoride to which approximately 107 ppm (v/v) hydrogen chloride, 119 ppm (v/v) hydrogen fluoride and 430 ppm (v/v) sulfur dioxide were added. After passage of the gas through the adsorbent bed, the impurities were below the detection limit.

### EXAMPLE 2

### Regenerating the Activated Carbon and Potassium Fluoride Sorbent Kit

The adsorbent vessel was heated to a temperature above 200° C. while a stream of nitrogen was passed through the bed. The gas leaving the adsorbent vessel was passed through a water scrubber. After regeneration it was possible to reuse the adsorbent vessel for purifying additional sulfuryl fluoride.

The foregoing description and examples have been set forth merely to illustrate the invention and are not intended to be limiting. Since modifications of the described embodiments incorporating the spirit and substance of the invention may occur to persons skilled in the art, the invention should be construed broadly to include all variations within the scope of the appended claims and equivalents thereof.

What is claimed is:

1. A method for purifying contaminated sulfuryl fluoride containing at least one contaminant selected from the group consisting of hydrogen fluoride, hydrogen chloride, sulfur dioxide and organic impurities, said method comprising contacting the contaminated sulfuryl fluoride with an alkali metal fluoride and recovering a purified sulfuryl fluoride.

2. A method according to claim 1, wherein the contaminated sulfuryl fluoride contains hydrogen fluoride, hydrogen chloride and sulfur dioxide.

3. A method according to claim 1, wherein the contaminated sulfuryl fluoride contains dichloroethane.

4. A method according to claim 1, wherein the contacting with an alkali metal fluoride is carried out at a temperature ranging from −20° C. to 150° C.

5. A method according to claim 4, wherein the contacting is carried out at a temperature ranging from 0° C. to 30° C.

6. A method according to claim 1, wherein the method is carried out immediately after synthesis of the contaminated sulfuryl fluoride.

7. A method according to claim 1, wherein the method is carried out immediately prior to or during use of the purified sulfuryl fluoride.

8. A method according to claim 1, further comprising regenerating used alkali metal fluoride laden with said at least one contaminant removed from the sulfuryl fluoride.

9. A method according to claim 1, wherein the alkali metal fluoride comprises potassium fluoride.

10. A sorbent kit comprising separate portions of an alkali metal fluoride and at least one adsorbent selected from the group consisting of activated carbon, silica gel and zeolites.
